(19) United States
(12) Patent Application Publication
(10) Pub. No.: US 2024/0144475 A1
(43) Pub. Date: May 2, 2024

(54) CAPILLARY ANALYSIS

(71) Applicant: ODI MEDICAL AS, Oslo (NO)

(72) Inventors: Maged HELMY, Oslo (NO); Anastasiya DYKYY, Oslo (NO); Svein-Erik MÅSØY, Oslo (NO); Haakon BRYHNI, Oslo (NO)

(21) Appl. No.: 18/280,369

(22) PCT Filed: Mar. 7, 2022
(86) PCT No.: PCT/EP2022/055767

§ 371 Date: Sep. 5, 2023

(30) Foreign Application Priority Data
Mar. 5, 2021 (GB) 2103133.1

(51) Int. Cl. G06T 7/00; G06T 1/20; G06T 7/11; G06T 7/20

(52) U.S. Cl. CPC G06T 7/0012; G06T 1/20; G06T 7/11; G06T 7/20; G06T 2207/10016; G06T 2207/10056; G06T 2207/20081; G06T 2207/20084; G06T 2207/30104

(57) ABSTRACT

An automated method for analysing capillaries in a plurality of images acquired from a subject. The method comprising the steps of: a) acquiring the plurality of images; b) generating a plurality of capillary candidate maps for each of said images, each capillary candidate map comprising one or more regions of interest for each of said images, wherein for each image, each of the respective capillary candidate maps is generated by comparing said image to a different criterion; c) combining said capillary candidate maps to generate a combined capillary candidate map; d) using a first neural network to determine a respective location of one or more detected capillaries in said combined capillary candidate map; e) using a second neural network to determine an optical flow of said detected capillaries; and f) extracting one or more capillary parameters using said detected capillaries and/or said determined flow.

### TECHNICAL FIELD

The present invention relates to automated techniques for the analysis of capillaries of a subject, particularly though not exclusively a human patient.

### BACKGROUND

Capillaries are the smallest blood vessels in the body measuring less than 20 micrometres in diameter [1]. The exchange of many nutrients with the interstitial fluid occurs here including water, oxygen, and other essential nutrients necessary for the maintenance of cellular metabolism [2], [3]. A network of capillaries constitutes the microcirculation of the body [4]. Studies assessing microcirculation reveal that capillary density and/or flow velocity is altered in several diseases [5]-[17]. Furthermore, some studies claim that changes in microcirculation occur early in disease progression and thus microcirculation monitoring could be used for early detection for various clinical conditions [12, 17].

Determining the density of capillaries allows us to understand the surface area available for the exchange of nutrients [18]. One study concludes that South Asians have a higher mortality rate from cardiovascular diseases compared with Caucasians, and capillary density can be used as an early marker [6]. A second study shows measuring capillary density can be a key component in understanding fibrotic diseases [19]. A study on chronic kidney disease has determined that a reduction in capillary density over time can be used as early detection to prompt timely interventions [20]. Quantifying the velocity of the red blood cells within the capillaries detected can help us understand fluid homeostasis and the transcapillary fluid flux [18]. One study concludes that alterations in the velocity of red blood cells within the capillaries influences the amount of supplies being delivered to the surrounding cells and the time it has to be exchanged across the microvascular wall to the surrounding tissues [21]. Another study shows that an increase in blood flow in the cerebral capillary blood flow can be due to a body response trying to regulate a decrease in oxygen tension in the neurons [22].

A common theme among microvascular analysis articles is the time-consuming, laborious tasks that require clinicians and researchers to manually (or semi-automatically) select capillaries and determine the velocity of the blood flow. Such jobs are strenuous on the eyes and are susceptible to errors and observer variations across different datasets.

On average it takes a trained researcher 20 minutes to analyse a 20-second-long microvascular video [23]. The long analysis time and training requirements are some of the reasons that hinder microvascular microscopy to be integrated into routine clinical practice [24]. Furthermore, manual analysis limits the number of parameters that can be analysed within a microvascular video. Flow velocity and capillary density are assessed, while intra-capillary flow heterogeneity, hematocrit and capillary morphology are not routinely recorded [24].

The Applicant has observed that all the above-mentioned parameters are altered in specific patient groups.

In a series of three meetings organized by international experts in microvascular microscopy it was concluded that an automatic assessment of the microcirculation is required in order to integrate microvascular microscopy into clinical practice [24]. It is an aim of the present invention to provide a method for the automatic assessment of microcirculation in microvascular videos.

Object detection in computer vision is one of the most challenging problems where the aim is to find the area occupied by an object instance in an image [25]. Deep learning is one of the powerful tools which significantly increased the mean average precision in object detection competitions (i.e., VOC 2007-2012, ILSVRC 2013-2017) since its arrival in 2012 [26], [27]. Before deep learning, salient detection (SD) methods were the state of the art in object detection [28]-[30].

The overall aim of the present invention is to lift the burden of the manual job from the professionals and allow them to focus on the method and hypotheses development. The goal is to provide an automated tool for the clinicians to easily quantify the capillaries and classify the erythrocyte velocity in microvascular videos.

### SUMMARY OF THE INVENTION

When viewed from a first aspect, embodiments of the present invention provide an automated method for analysing capillaries in a plurality of images acquired from a subject, the method comprising the following steps:
a) acquiring the plurality of images;
b) generating a plurality of capillary candidate maps for each of said images, each capillary candidate map comprising one or more regions of interest for each of said images, wherein for each image, each of the respective capillary candidate maps is generated by comparing said image to a different criterion; c) combining said capillary candidate maps to generate a combined capillary candidate map;
d) using a first neural network to determine a respective location of one or more detected capillaries in said combined capillary candidate map; e) using a second neural network to determine an optical flow of said detected capillaries; and
f) extracting one or more capillary parameters using said detected capillaries and/or said determined flow.

This first aspect of the invention extends to a device arranged to carry out automated analysis of capillaries in a plurality of images acquired from a subject, the device comprising:
an image acquisition module arranged to acquire the plurality of images; and
a processing module arranged to:
   generate a plurality of capillary candidate maps for each of said images, each capillary candidate map comprising one or more regions of interest for each of said images, wherein for each image, each of the respective capillary candidate maps is generated by the processing module by comparing said image to a different criterion;
   combine said capillary candidate maps to generate a combined capillary candidate map;
   use a first neural network to determine a respective location of one or more detected capillaries in said combined capillary candidate map;
   use a second neural network to determine an optical flow of said detected capillaries; and
   extract one or more capillary parameters using said detected capillaries and/or said determined flow.

The first aspect of the invention also extends to a non-transitory computer-readable medium comprising instructions that, when executed by a processor, cause the processor to carry out an automated method for analysing capillaries in a plurality of images acquired from a subject, the method comprising the following steps:
a) acquiring the plurality of images;
b) generating a plurality of capillary candidate maps for each of said images, each capillary candidate map comprising one or more regions of interest for each of said images, wherein for each image, each of the respective capillary candidate maps is generated by comparing said image to a different criterion;
c) combining said capillary candidate maps to generate a combined capillary candidate map;
d) using a first neural network to determine a respective location of one or more detected capillaries in said combined capillary candidate map;
e) using a second neural network to determine an optical flow of said detected capillaries; and
f) extracting one or more capillary parameters using said detected capillaries and/or said determined flow.

The first aspect of the invention further extends to a computer software product comprising instructions that, when executed by a processor, cause the processor to carry out an automated method for analysing capillaries in a plurality of images acquired from a subject, the method comprising the following steps:
a) acquiring the plurality of images;
b) generating a plurality of capillary candidate maps for each of said images, each capillary candidate map comprising one or more regions of interest for each of said images, wherein for each image, each of the respective capillary candidate maps is generated by comparing said image to a different criterion;
c) combining said capillary candidate maps to generate a combined capillary candidate map;
d) using a first neural network to determine a respective location of one or more detected capillaries in said combined capillary candidate map;
e) using a second neural network to determine an optical flow of said detected capillaries; and
f) extracting one or more capillary parameters using said detected capillaries and/or said determined flow.

Thus it will be appreciated that embodiments of the present invention provide an improved approach for the analysis of capillaries in which capillaries can be detected in images (e.g. microvascular videos) and the velocity of red blood cells can be classified. As outlined in further detail below, embodiments of the present invention may combine deep learning methods with rule-based algorithms and two-frame motion estimation techniques. The approach outlined herein may fully automate the analysis of capillaries, while providing a high degree of accuracy and performance. The method may, in some embodiments, be a method of identifying or monitoring circulatory failure in a subject.

The term ‘subject’ as used herein includes any human or non-human animal subject, including any human or non-human mammal, bird, fish, reptile, amphibian, etc. However, in preferred embodiments the subject is a human mammal, e.g. a human patient.

In some embodiments, the method is a non-invasive method. In other embodiments, the method is an invasive method.

The plurality of images may be acquired as independent images (i.e. ‘stills’), however in some embodiments the plurality of images form a video. In a set of such embodiments, the method comprises acquiring a plurality of videos, wherein the analysis is carried out in respect of said plurality of videos. For example, approximately five videos may be used. The videos may be of any suitable length, however in some particular embodiments, each video may be approximately 20 seconds long.

In a preferred set of embodiments, the images are microscopy images (or videos, as appropriate). In some embodiments in which a microscope probe is used, the microscope may be a computer assisted video microscope (CAVM). The microscopy images may be pre-existing (e.g. generated using a microscope or CAVM), however in some embodiments the step of acquiring the images comprises using a microscope probe to generate said images.

In some such embodiments, the method may comprise positioning the microscope probe on a body surface of the subject. For example, the body surface could be the skin, eye, tongue, nails, or any other internal or external body surface as appropriate. However, in some embodiments, the body surface comprises the subject's skin.

The images acquired may be readily usable for the following capillary analysis steps. However, the Applicant has appreciated that, in some embodiments, it may be advantageous to carry out one or more image enhancement processes on the images, e.g. prior to generating the capillary candidate maps. By performing a dynamic range optimisation of the colours and/or carrying out appropriate image processing techniques, known in the art per se, the image quality may be improved or optimised to enhance performance of the capillary analysis process. In some embodiments, the method further comprises carrying out one or more of:
a) modifying a colour balance of one or more of said images;
b) modifying a white balance of one or more of said images;
c) modifying a light level of one or more of said images;
d) modifying a gamma level of one or more of said images;
e) modifying a red-green-blue (RGB) curve of one or more of said images;
f) applying a sharpening filter to one or more of said images; and/or
g) applying a noise reduction process to one or more of said images.

The above image enhancement steps may be particularly advantageous when the images, e.g. microscopy images, have a large dynamic range of colours and wavelengths. The image enhancement techniques listed above may be applied in an appropriate combination to compensate the data to improve the visualisation for the automated processing algorithm.

The Applicant has appreciated that the images may be subject to some unwanted artefacts from motion that occurred during the capture of those images. For example, where a microscope probe is used (e.g. a handheld microscopy probe), the images captured may be subject to some motion effects due to motion of the probe in use. In some embodiments, the method further comprises carrying out a motion compensation process, e.g. prior to generating the capillary candidate maps. The motion compensation process may comprise removing translation, rotation, and/or depth changes which may, for example, arise due to varying pressure applied to the microscope.

As outlined above, multiple maps are generated according to different processes for each of the images, and these maps are subsequently combined. The step of generating these maps may, in some embodiments, comprise inputting each image to a plurality of pipelines. The step of combining the capillary candidate maps to generate the combined capillary candidate map may be carried out using statistical methods. For example, each of the capillary candidate maps (or the pipelines from which they originate) may have a respective likelihood score, either for the overall map or for each RoI it contains. A maximum likelihood function may be carried out taking each capillary candidate map for a given image as an input where the likelihoods for each potential RoI are combined and compared to some threshold to determine whether, balancing all of the different pipeline's contributions, any given region is an area that might reliably contain a capillary. Different weights may be applied to the different pipelines, where these weights may be fixed or may be determined dynamically.

In some embodiments, a first pipeline is arranged to generate a first capillary candidate map, said first pipeline being arranged to generate an image histogram from each image and determines an optimal pixel value threshold, said first pipeline being further arranged to classify each pixel in said image with a first label if a value of said pixel is less than the determined optimal pixel value threshold, and with a second label if the value of said pixel is equal to or greater than the determined optimal pixel value threshold. The first pipeline may then generate a respective set of RoIs based on the labelled pixels. The determination of the optimal pixel value threshold may be carried out using Otsu's algorithm, known in the art per se. The first and second labels may be pixel values of 0 and 255 respectively, however it will be appreciated that other pixel values could be used. Thus, in some embodiments, the first pipeline carries out a binary threshold that checks if the value of each pixels in a given image are less than the derived number (i.e. the optimal pixel value threshold) and sets it to 0; otherwise, it sets it to 255.

Additionally, or alternatively, in some embodiments, a second pipeline is arranged to generate a second capillary candidate map, said second pipeline being arranged to compare a pixel value of each pixel in each image to a truncation threshold, said second pipeline being further arranged to set the value of each pixel having a pixel value greater than said truncation threshold to said truncation threshold. It will be appreciated that, in accordance with such embodiments, any pixels having values in excess of the maximum allowed value (i.e. the truncation threshold) are ‘cut-off’ or ‘clipped’ at that maximum. The second pipeline may then generate a respective set of RoIs based on the labelled pixels.

Additionally, or alternatively, in some embodiments, a third pipeline is arranged to generate a third capillary candidate map, said third pipeline being arranged to rescale an intensity of the image and to apply a threshold value to said rescaled image according to an adaptive mean. This third pipeline may apply a binary thresholding process based on the threshold value of the third pipeline, such that pixels having a value below the threshold are labelled with a first label (e.g. 0) and pixels having a value equal to or above the threshold are labelled with a second label (e.g. 255). The third pipeline may then generate a respective set of RoIs based on the labelled pixels.

Additionally, or alternatively, in some embodiments, a fourth pipeline is arranged to generate a fourth capillary candidate map, said fourth pipeline being arranged to adjust an image sigmoid using a cut-off and gain and to apply a binary thresholding process. As above, the binary thresholding process may label each pixel according to whether it is below the respective threshold of the fourth pipeline or not. The fourth pipeline may then generate a respective set of RoIs based on the labelled pixels.

Additionally, or alternatively, in some embodiments, a fifth pipeline is arranged to generate a fifth capillary candidate map, said fifth pipeline being arranged to rescale the intensity of the image and to apply a binary threshold. The binary threshold simply checks if the value of the pixel is less than the threshold (i.e. a particular number) and if so, labels that pixel with a first label (e.g. 0); otherwise, it labels it with a second label (e.g. 255). The fifth pipeline may then generate a respective set of RoIs based on the labelled pixels. The binary threshold used for this fifth pipeline may, in some embodiments, may be a predetermined threshold. The appropriate threshold may be determine experimentally.

Additionally, or alternatively, in some embodiments, a sixth pipeline is arranged to generate a sixth capillary candidate map, said sixth pipeline being arranged to detect a movement between subsequent images (i.e. adjacent frames) and to label a region of the image associated with said movement as a region of interest.

It will be appreciated that the terms ‘first’ through ‘sixth’ are used for ease of reference, and embodiments of the present invention are envisaged that utilise any suitable combination and permutation of the above six pipelines, in any suitable subset or superset thereof. However, in a preferred set of embodiments, all six of the above pipelines are provided, and their respective outputs combined.

Each of these pipelines suggests a respective set of RoIs, which are generally different for each pipeline. The RoIs may then be projected back onto the original image. These sets of RoIs may, in some embodiments, be processed using a non-max suppression process to replace overlapping RoIs.

The use of multiple different pipelines is particularly advantageous because the different pipelines generally perform differently with different illumination and different skins types. By combining the outputs of each of the pipelines on each of the images (or videos), the probability of detecting all capillaries can be improved and ideally maximised.

The Applicant has appreciated that one or more of the pipelines may generate one or more false positive RoIs (i.e. areas labelled as being capillaries that do not, in reality, contain a capillary). The first neural network used by embodiments of the present invention acts to combine the RoIs from these pipelines in order to classify whether the RoI contains a capillary.

The first and second neural networks typically comprise different neural networks. Each of the neural networks may be trained using appropriate training data. The first neural network may be trained using validated training data. Thus, in some embodiments, the method comprises generating a validated training data set by manually labelling a plurality of capillaries in a plurality of images and supplying said validated training data set to the first neural network during a training phase. Thus the first neural network can learn from the manually labelled images (which may be labelled by a trained researched) so that it may determine the location of capillaries in a new image the neural network has not seen before.

Thus the first neural network may, in general, be trained using a prior data set comprising pre-labelled capillaries. By training the first neural network using images and/or videos labelled in advance (e.g. by a human being trained to do so), the first neural network can learn patterns so as to better be able to determine from a new data set (i.e. the combined capillary map generated using the newly acquired images taken from the subject), where the capillaries are.

The first neural network may, in some embodiments, comprise a convolutional neural network (CNN). The Applicant has appreciates that CNNs and deep neural networks are particularly well-suited to finding the capillaries features across a set of images and provide significant improvements in the are ability to distinguish capillaries from non-capillaries. Once the RoIs are obtained, CNNs provide high performance both in terms of speed and precision for determining whether or not there is a capillary a given RoI.

The Applicant has appreciated that, if the plurality of images (e.g. video) has been stabilized or if there is no recording motion (e.g. due to hand movement), capillaries can potentially be detected using only a single frame (i.e. a single image). In some particularly advantageous arrangements, all capillaries present may be detected within a single image. In some embodiments, this is achieved by applying a Gaussian model to separate the background of the image from the foreground of the image. The resulting single frame may contain a number of RoIs (e.g. approximately 300 RoI), which are snippets of different parts of the image with different sizes. The first neural network (which, as above, may comprise a CNN) may then classify whether each of these RoIs has a capillary or not. This advantageously eliminates the need to take a mean value across the whole video (as is required by some prior art approaches, known in the art per se) and allows each frame to be handled independent with its own frame-specific values. This also brings us closer to real-time capillary detection since it is not necessary to wait for the whole video to be recorded to get the mean value, but rather we can start detecting capillaries from a single independent frame.

Once the capillaries have been detected in the combined capillary candidate map, the detected capillaries may be passed to a velocity detection stage for the determination of optical flow of the capillaries. The determination of the optical flow may, in some embodiments, comprise applying a Gunnar Farneback algorithm (GFA) to the detected capillaries prior to use of the second neural network. The GFA is a two-frame motion estimation algorithm where approximation is done by calculating the quadratic polynomials and polynomial expansion transform between each frame (i.e. between subsequent ones of the plurality of images). The determined polynomial expansion coefficients are used to derive the displacement fields of the pixels, assuming the pixel intensities are constant between the two frames. The difference in the locations of the pixels becomes the velocity vector value for that capillary.

The velocity vector value of each detected capillary may, in some embodiments, be compared to a velocity vector threshold, wherein a velocity of said detected capillary is classified using the result of said comparison. If the velocity vector value for a given capillary is below the threshold, it may be determined that the capillary has no movement. Conversely, if the velocity vector value for a given capillary is above the threshold, it may be determined that the capillary has movement, which may be constant or intermittent movement.

In some embodiments, only capillaries having a velocity vector value above the velocity vector value threshold are passed to the second neural network. In other words, capillaries classified as having no movement are, at least in some embodiments, not assessed using the second neural network. The Applicant has appreciated that using the second neural network to classify ‘no-movement’ capillaries is superfluous and adds time and computational resource overheads. The GFA algorithm therefore acts as a pre-filter to the second neural network and is able to determine if a capillary is worth passing to the second neural network in near real-time. Conversely, if the velocity vector value is above the threshold, the second neural network may be used to classify the capillary as having either constant or intermittent flow. The direction of flow and intra-capillary flow between frames for that capillary may then be determined.

A stabilizing algorithm may be applied to the frames before passing it to GFA. This stabilizing algorithm may be used to offset any variance in pixel locations arising due to inadvertent movement during the capture of the images, e.g. due to movement of the microscope probe and/or movement of the subject.

The second neural network may, in some embodiments, comprise a deep neural network (DNN). It will be appreciated that a DNN is a neural network having multiple layers between its input layer and output layer, where the successive intermediate layers extract successively higher-level features from the raw input (i.e. the images).

The velocity vector threshold may be set to a suitable value. However, in some embodiments, the velocity vector threshold is between approximately 1.0 and 1.5, optionally between approximately 1.1 and 1.4. In some such embodiments, the velocity vector threshold is approximately equal to 1.2, and may in some such embodiments be equal to 1.2.

Thus, in a particular set of embodiments, if the velocity vector value is under 1.2 the capillary is classified as having no movement; and if the velocity vector is larger than 1.2 it is passed to a deep learning algorithm to classify its velocity as having a constant flow or intermittent flow, and to determine the direction of flow and intra-capillary flow between frames.

Using the GFA together with a DNN to learn the velocity classification from a trained researcher provides significant benefits. In particular, this velocity detection method can be considered as an alternative way to the space-time diagram and manual eye analysis approach, currently used in the art. Advantageously, by using the GFA and DNN, there is no need for a central line to deduce the velocity, thus reducing the steps needed to detect velocity. The GFA may also, in some embodiments, be used to deduce the intra-capillary flow heterogeneity. This makes our method more accurate in tracking red blood cells since we do not singly rely on a central line accurately placed between the frames.

In a set of embodiments, the method comprises performing quality analysis on one or more of the plurality of images to determine whether said images meet a quality threshold. The quality threshold may be determined by analysing the image to determine whether the image quality is sufficient for further processing. This analysis may comprise detecting whether the image is: out of focus (i.e. the quality threshold may comprise an image sharpness threshold); too dark (i.e. the quality threshold may comprise an image brightness threshold); or contains motions too large to be compensated (i.e. the quality threshold may comprise an image motion threshold).

In some embodiments, the area of each detected capillary is calculated based on the area occupied by the pixels associated with said detected capillary. In other words, the total amount of pixels within the capillary's boundary may constitute the area of that particular capillary. We can then proceed to calculate the heterogeneity of the perfusion of the capillary to monitor how much red blood cell flows through the capillary. In this way, we are not only able to detect the capillary and its area, but also proceed to detect how much blood flows through it across time. This can provide the clinician with information of the average capillary hematocrit and its variation over time.

In some embodiments, the parameter comprises one or more of the group comprising:
a) functional capillary density (number of capillaries per square millimetre);
b) mean capillary distance—average distance of nearest-neighbour pairs of capillaries;
c) capillary flow velocity (CFV)—either quantified in an ordinal scale or by a velocity (e.g. millimetre per second);
d) the size of each capillary;
e) the colour density of each capillary, which is related to the level of oxygenation of the red blood cells; and/or
f) the blood area or blood volume—the area or estimated volume occupied by the capillaries in relation to the total area or volume.

Such parameters may then be used to assess the subject's microcirculation.

The parameters extracted from the images may be interpreted by a human reader or a machine learning algorithm trained to interpret the results, e.g. based on clinical trials and patient outcomes for a variety of different diseases. In some embodiments, a report comprising the extracted parameters is generated and provided as an output.

The Applicant has appreciated that the arrangement described herein may advantageously detect capillaries using only a single image, using a neural network. Thus, when viewed from a second aspect, embodiments of the present invention provide an automated method for analysing capillaries in an image acquired from a subject, the method comprising the following steps:
a) acquiring the image;
b) generating a plurality of capillary candidate maps for said image, each capillary candidate map comprising one or more regions of interest, wherein each of the respective capillary candidate maps is generated by comparing said image to a different criterion;
c) combining said capillary candidate maps to generate a combined capillary candidate map;
d) using a neural network to determine a respective location of one or more detected capillaries in said combined capillary candidate map; and
e) extracting one or more capillary parameters using said detected capillaries.

This second aspect of the invention extends to a device arranged to carry out automated analysis of capillaries in an image acquired from a subject, the device comprising:
an image acquisition module arranged to acquire the image; and
a processing module arranged to:
   generate a plurality of capillary candidate maps for said image, each capillary candidate map comprising one or more regions of interest, wherein each of the respective capillary candidate maps is generated by the processing module by comparing said image to a different criterion;
   combine said capillary candidate maps to generate a combined capillary candidate map;
   use a neural network to determine a respective location of one or more detected capillaries in said combined capillary candidate map; and
   extract one or more capillary parameters using said detected capillaries.

The second aspect of the invention also extends to a non-transitory computer-readable medium comprising instructions that, when executed by a processor, cause the processor to carry out an automated method for analysing capillaries in an image acquired from a subject, the method comprising the following steps:
a) acquiring the image;
b) generating a plurality of capillary candidate maps for said image, each capillary candidate map comprising one or more regions of interest, wherein each of the respective capillary candidate maps is generated by comparing said image to a different criterion;
c) combining said capillary candidate maps to generate a combined capillary candidate map;
d) using a neural network to determine a respective location of one or more detected capillaries in said combined capillary candidate map; and
e) extracting one or more capillary parameters using said detected capillaries.

The first aspect of the invention further extends to a computer software product comprising instructions that, when executed by a processor, cause the processor to carry out an automated method for analysing capillaries in an image acquired from a subject, the method comprising the following steps:
a) acquiring the image;
b) generating a plurality of capillary candidate maps for said image, each capillary candidate map comprising one or more regions of interest for said image, wherein each of the respective capillary candidate maps is generated by comparing said image to a different criterion;
c) combining said capillary candidate maps to generate a combined capillary candidate map;
d) using a neural network to determine a respective location of one or more detected capillaries in said combined capillary candidate map; and
e) extracting one or more capillary parameters using said detected capillaries.

It will be appreciated that the optional features described hereinabove in respect of embodiments of the first aspect of the invention apply equally to the second aspect of the invention. Unless explicitly stated otherwise, any and all features of any given embodiment of either aspect of the invention described herein may be combined with any other embodiment described herein.

### BRIEF DESCRIPTION OF DRAWINGS

Certain embodiments of the invention will now be described, by way of example only, with reference to the accompanying drawings in which:

FIG. 1 is a block diagram of a system arranged to carry out capillary analysis in accordance with an embodiment of the invention;

FIG. 2 is an image extracted from a video with skin dirt and microscope artefacts;

FIG. 3A is an image of a capillary filled with red blood cells;

FIG. 3B is an image of a capillary partially filled with plasma gaps or white blood cells;

FIG. 3C is a graph showing how much a capillary is filled with red blood cells (capillary hematocrit) across time;

FIG. 4 is a graph shows showing the velocity vector of capillaries classified as either having no flow or flow;

FIGS. 5A and 5B are graphs showing the intra-capillary flow of two different capillaries;

FIG. 6A is a schematic illustration of the skin region in which the microvascular videos were recorded is shown;

FIG. 6B is an image from the captured video;

FIG. 6C is an image showing capillaries detected using the system in accordance with an embodiment of the present invention;

FIG. 7 is a block diagram of the architecture of six pipelines used to carry out an embodiment of the present invention;

FIG. 8 is a block diagram of a deep neural network suitable for use in the capillary detection method of the present invention;

FIGS. 9A-F are images showing the outputs of each of the pipelines of FIG. 8;

FIGS. 10A and 10B are images respectively showing the output of the max suppression and convolution neural network-based classification steps;

FIGS. 11A-C are images showing the detection of a capillary and its occupied area;

FIG. 12 is a flowchart illustrating an algorithm for determining capillary velocity;

FIG. 13 is a further flowchart illustrating an algorithm for determining capillary velocity;

FIG. 14A is an image showing a video demonstrating capillary flow;

FIG. 14B is a graph showing the velocity vector across the video frames; and

FIG. 14C is an image indicating flow direction of the capillary, automatically derived by the system of the present invention.

### DETAILED DESCRIPTION

An exemplary embodiment of the present invention is described herein and is referred to as ‘CapillaryNet’. For capillary detection, we compare the training time, detection time and accuracy of our method against the state-of-the-art object detection algorithms with Mask R-CNN [31] and capillary annotation as performed by trained researchers. Furthermore, we compare our architecture with other state-of-the-art capillary detection architectures. We show that our approach is more accurate than the state-of-the-art and more efficient than the annotations of the trained researchers. For velocity detection, we benchmark the results of state-of-the-art manual red blood cell flow velocity classification performed by researchers against the velocity classification detected by CapillaryNet.

Mask R-CNN algorithm is one of the top-ranked object detection algorithms [1]. Mask R-CNN with a ResNeXt101-FPN achieved state-of-the-art results on the Coco dataset (80 object categories with 1.5 million object instances) [32] for object segmentation. Mask R-CNN architecture extends Faster R-CNN [33] by adding a branch to predict the segmentation mask of each Region of Interest (RoI) on a pixel-to-pixel basis. The method for object segmentation which is introduced by Mask R-CNN is the ‘RoI align’ which preserves the pixel spatial correspondences. It replaces the quantization from the RoI pooling with bilinear interpolation.

The accuracy of capillary detection between Mask R-CNN and CapillaryNet was calculated based on mean average precision (mAP) and Intersection over Union (IoU) with the labelled data. These are the common evaluation measures used to benchmark object detectors performance in supervised learning algorithms [26], [31].

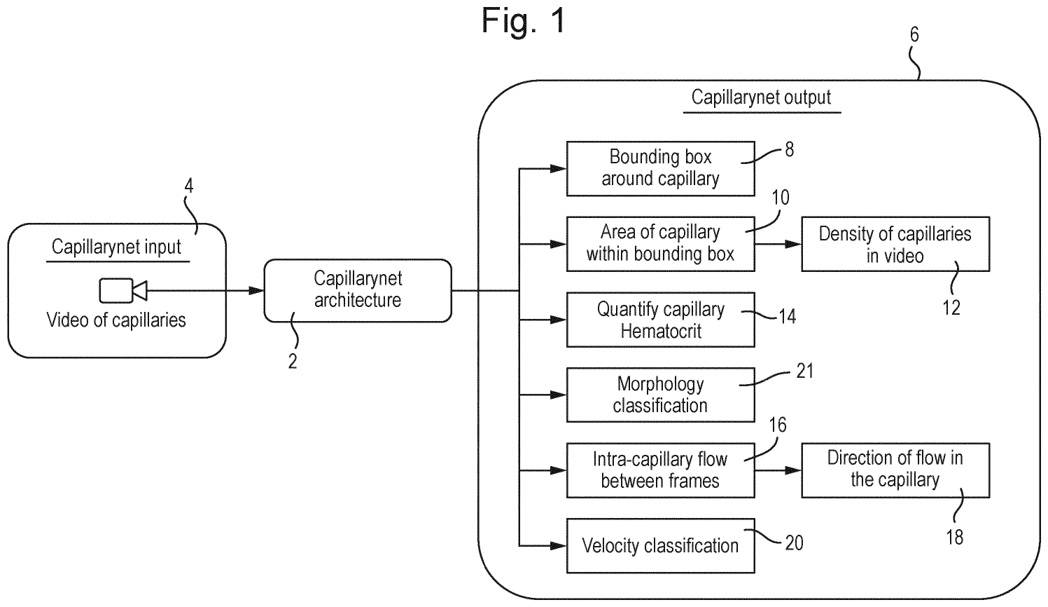

The input and outputs of CapillaryNet are shown in FIG. 1. In particular, the CapillaryNet system 2 is arranged to receive an input 4 comprising a video of capillaries of a subject. The term ‘video’ should be understood to mean a sequence of images over time. In general, the system 2 may be supplied with a sequence of still images (e.g. photographs taken over a period of time) and/or with multiple videos.

The CapillaryNet system 2 carries out processing on these images—as is described in further detail below—and produces several outputs 6. In particular, the CapillaryNet system 2 produces: a bounding box around each capillary 8; an area of the capillary within the bounding box 10; a density of the capillaries in the video 12; a quantification of the capillary hematocrit 14; a measure of the intra-capillary flow between frames 16; the direction of flow in the capillary 18; and a classification of velocity 20. The CapillaryNet system 2 is also able to perform morphology detection 21.

The accuracy of CapillaryNet in capillary detection exceeded that of Mask R-CNN by 25% (92.5% and 67.5% respectively). The total time used to train the CapillaryNet was approximately 1 hour, which is significant less than that needed for the Mask R-CNN approach, which took approximately 120 hours, as shown in Table 1. The algorithms were tested on an Asus GPU 2080Ti 11 GB with 32 GB Ram on an i7-8850H processor.

The reason why Mask R-CNN has a slower training time is because of the sheer number of parameters that needs to be fine-tuned. Mask R-CNN has 63,621,918 trainable parameters while CapillaryNet has 6,786,978 parameters. CapillaryNet has ˜10.67% of the size of Mask R-CNN due to the shallower convolutional neural network (CNN) used. Furthermore, having fewer parameters allows us to detect capillaries much faster and more efficiently allowing us to get closer to near real-time capillary detection with just over 4 frames per second.

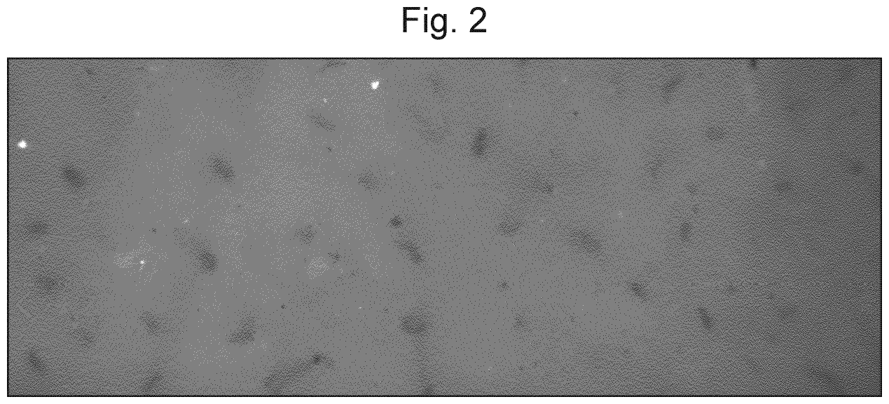

The reason why Mask R-CNN was less accurate is due to factors arising from the nature of the skin profile and the properties of the lens. This causes varied illumination on different parts of the skin, blur due to the size of a capillary relative to the image, camera shake detected while recording and occlusion due to hair, stains and other artefacts on the skin, as can be seen in the photograph of FIG. 2. The photograph of FIG. 2 shows an image extracted from a video with skin dirt and microscope artefacts, which make some parts of the video blurry and out of focus. Using purely rule-based algorithms to detect capillaries, as per some prior art arrangements, will lead to the detection of the dirt too due to similarities in sizes.

These issues make it challenging for the Mask R-CNN and any other convolutional neural network (CNN) RoI based detector to generalize with accuracy equivalent to the trained researcher manual labelling.

CapillaryNet architecture aims to tackle the challenges posed by the profile of the skin by applying several methods to detect RoIs instead of pure CNNs. These RoI detection methods are computationally less expensive in comparison to the Mask R-CNN RoI detection step, making CapillaryNet faster as shown in Table 1 above. By combining salient detection methods with convolutional neural networks, the approach of the present invention provides the ability to distinguish between capillaries and dirt.

Dobble et. al [34] uses a frame averaging method to remove the plasma and white blood cells gaps within the capillary before using an algorithm to detect capillaries. Using frame averaging can lead to a lower overall density calculation since capillaries with many gaps or insufficient blood flow will be disregarded. Furthermore, Dobble et al [34] removes capillaries that are out of focus, since they consider it to add noise to the frame averaging method. From our experiments with handheld microscopy, the nature of a rounded lens on a typical microscope probe may lead to 40% out of focus images on both edges of the video. It is particularly challenging to have a fully focused video the whole time and some parts can always be out of focus. Therefore, this will further significantly reduce the capillary density values. We compensate for the mentioned drawbacks by making the CNN robust against out-of-focus capillaries by training the CNN on real captured data.

Hilty et. al [23] has a similar flow as Dobble et al [34] with minor tweaks. Hilty et al [23] detect capillaries by first generating a mean image across all frames and then passing the resulting image to two pipelines, firstly classifying vessels of 20-30 μm (diameter) as capillaries, secondly any vessel of up to 400 μm (diameter) as venuels. The capillaries are then passed to a modified curvature-based region detection algorithm [35] to an image that has been stabilized and equalized with an adaptive histogram. The result is a vessel map that contains centrelines across structures that are between 20-30 μm wide. As stated by the authors of the curvature-based region detection algorithm [35], this type of detection is unintelligent and can lead to detecting artefacts such as hair or stains with similar sizes.

Furthermore, due to the profile of the skin challenges stated above, the mean of the images across the whole video is not always the best representation value since different parts of the video might have different lighting or capillaries can be out of the optimal focus. Moreover, videos that have slight motion will have to be completely disregarded since the central line is calculated across all frames instead of per frame.

CapillaryNet takes a different approach to tackle all these challenges. Instead of taking the mean of the image, CapillaryNet applies two independent methods. The first method analyses the frame as an individual and contains 5 steps, the second method analyses the video as a whole and looks at consecutive frames. This means if the video is stabilized or with no recording motion due to hand movement, we can detect all the capillaries present in a single frame only. This is achieved by applying a Gaussian model to separate the background from the foreground. The resulting single frame contains ˜300 RoI which are snippets of different parts of the image with different sizes, and a CNN classifies if this region has a capillary or not. This way we eliminate the need to take a mean value across the whole video and treat each frame uniquely with its own values. This also brings us closer to real-time detection since we do not need to wait for the whole video to be recorded to get the mean value, but rather we can start detecting capillaries from a single independent frame.

Similar to Dobble et al [34], Bezemer et al [38] improves the method by using 2D cross correlation to fill up the blood flow gaps caused by plasma and white blood cells. CapillaryNet tackles this issue by using a well-trained CNN to be able to detect capillaries even if they have plasma and white blood cells gaps.

Tam et al [36] detect capillaries through a semi-automated method which requires the user to select points on the image. The algorithm then decides if there is a capillary present. Conversely, the method of the present invention eliminates the need for user input by automatically detecting if a region has a capillary or not.

Geyman et. al [37] takes more of a manual approach by first using a software to click away the major blood vessels and then applying hardcoded calculations to detect the total number capillaries based on the number of pixels in the region-of-interest. This is quite a manual approach and highly susceptible to observer variations across different datasets. CapillaryNet reduces the observer variations factor by attaching a CNN to classify the RoIs. This CNN is trained on a validated capillary dataset set labelled by trained researchers.

Demir et. al [39] uses CLAHE with a median filter and an adjustable threshold to detect capillaries on the weighted mean of five consecutive frames. However, these methods need to be adjusted accordingly depending on the illumination on the video and thickness of the skin. This introduces a manual job where the user must find the right combination of values for different videos, or the same video with different illumination. CapillaryNet tackles this issue by passing the image into several different independent methods (six, in this case) and a CNN that will be able to determine whether or not the RoI has a capillary based on trained data.

Detecting capillary hematocrit can provide a clinician with information regarding the potential of each capillary to deliver oxygen to the surrounding tissue. To our knowledge, so far, only capillary density and flow velocity was assessed in studies. However, if capillaries have a normal flow and are normally distributed but show a low concentration of red blood cells (i.e. low hematocrit) the oxygen delivery ability of the microcirculation may be compromised. CapillaryNet can detect how much a capillary is filled with red blood cells (hematocrit) over time.

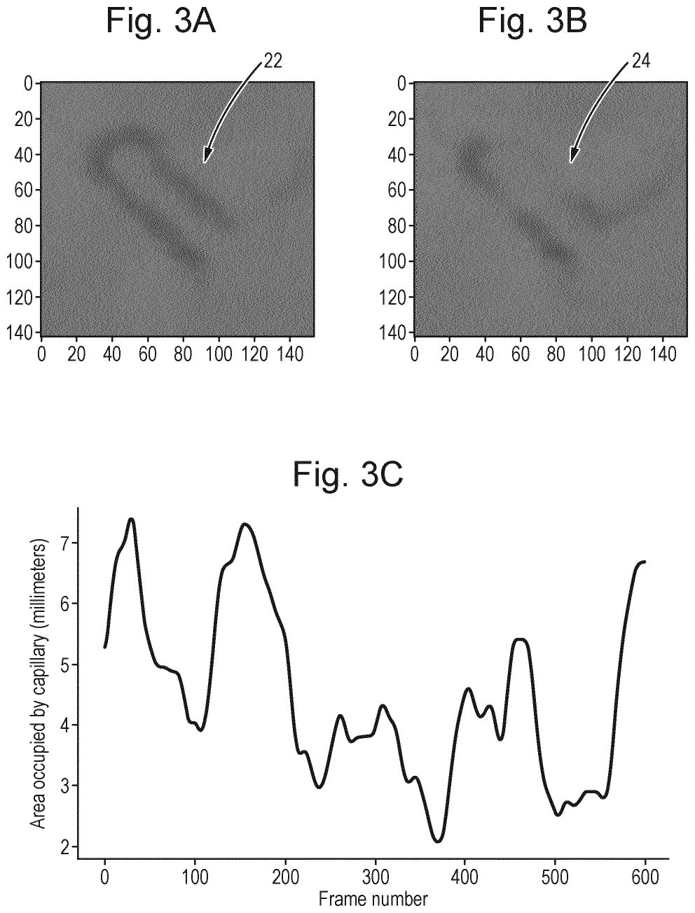

FIGS. 3A-C show the output from CapillaryNet displaying how hematocrit changes over time in a capillary. FIG. 3A is a photograph of a capillary 22 filled with red blood cells. FIG. 3B is a photograph of a capillary 24 partially filled with plasma gaps or white blood cells. FIG. 3C is a graph showing how much a capillary is filled with red blood cells (i.e. the capillary hematocrit) across time.

The quantification of red blood cell flow is a more challenging task than capillary detection. Some papers base their red blood cell flow on manual quantification of the red blood cell with different scales [40H43] which is subject to intra-individual variation. In manual quantification each individual vessel receives a score representing the average flow velocity estimated by a researcher. Flow velocity scales vary between publications some researchers classifying flow on a scale from 0 to 2 (absent, intermittent, or continuous flow) [1], others on a scale between 0 to 3 (absent, intermittent, sluggish, or normal flow) [1], while others on a scale from 0 to 5 (no-flow, sluggish, continuous very low, continuous low, continuous high, or brisk flow) [44].

More recent papers use space-time diagrams [23], [38], [45] to quantify red blood cell flow. Space-time diagrams (STD) is a fundamental improvement over the manual eye analysis since it is independent of the individual performing the analysis [34], [42]. However, it comes with its own drawback—it is very sensitive to the slightest movements since it strictly counts on the central line being at the centre of the capillary between all the frames in order to have an accurate space-time diagram. Therefore, if the position or width of the capillary changes between the frames due to camera shake or flow variation, the user must re-calibrate the central line to plot an accurate diagram. This might add an extra task to velocity classification which can be prone to errors and user bias. Furthermore, to construct an accurate central line we are dependent on identifying the exact width and length of the capillaries in the earlier stage. Therefore, capillaries that get out of focus must be disregarded since fitting the central line to plot the STD will not be accurate.

CapillaryNet overcomes the limitation by using the Gunnar Farneback algorithm with deep neural networks to learn the velocity classification from a trained researcher. Thus, our velocity detection method can be considered as an alternative way to the space-time diagram and manual eye analysis which is considered as the gold standard for RBC velocity classification [23]. We do not need the central line to deduce the velocity therefore we reduce the steps needed to detect velocity.

Furthermore, we use the Gunnar Farneback algorithm to deduce the intra-capillary flow heterogeneity. This makes our method more accurate in tracking red blood cells since we do not singly rely on a central line accurately placed between the frames. We benchmarked our velocity detection classification against manually labelled red blood cell flow velocities on capillary videos. Our method had an average accuracy of 88% in classifying the velocity of the capillaries in comparison to the trained researcher, as shown in Table 2.

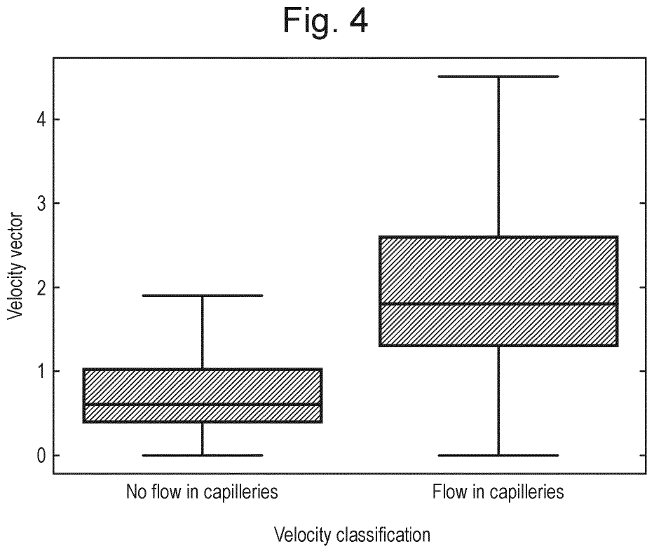

The average velocity vector calculated by the Gunnar Farneback algorithm for capillaries that had no movement was <˜1.03, and those that had intermittent flow or constant flow was >˜1.21, as can be seen in FIG. 4.

By taking these velocity vector values into consideration, we labelled bounding boxes with an average velocity of 1.2 or lower as no movement while the rest was passed on to a deep neural network to classify if it was capillaries with constant or intermittent flow. The accuracy was not closer to 100% since some capillaries flow in 3D (out and into the skin) instead of 2D (across the skin). Capillaries with such flow were misclassified the most.

As can be seen in the graph of FIG. 4, after a capillary is detected it is passed on to the Gunnar Farneback algorithm to derive the velocity vector of the bounding box.

The graph of FIG. 4 shows the velocity vector of capillaries that were classified with no flow (velocity vector<1.2) or flow (velocity vector>1.2).

Flow velocity within a capillary has been calculated in previous studies as an average value. The Applicant has appreciated that healthy subjects have a relatively homogeneous flow velocity, while in certain patient groups the flow velocity varies significantly throughout the duration of the video (e.g. 20 seconds). Obtaining one average value for each capillary does not allow the clinicians to detect this difference. Therefore, measuring the intra-capillary flow velocity heterogeneity has the potential to be used as an additional marker to detect compromised microcirculation. Clinical studies will need to be conducted in order to elucidate the potential of intra-capillary flow velocity heterogeneity and capillary hematocrit as markers for abnormal microcirculation.

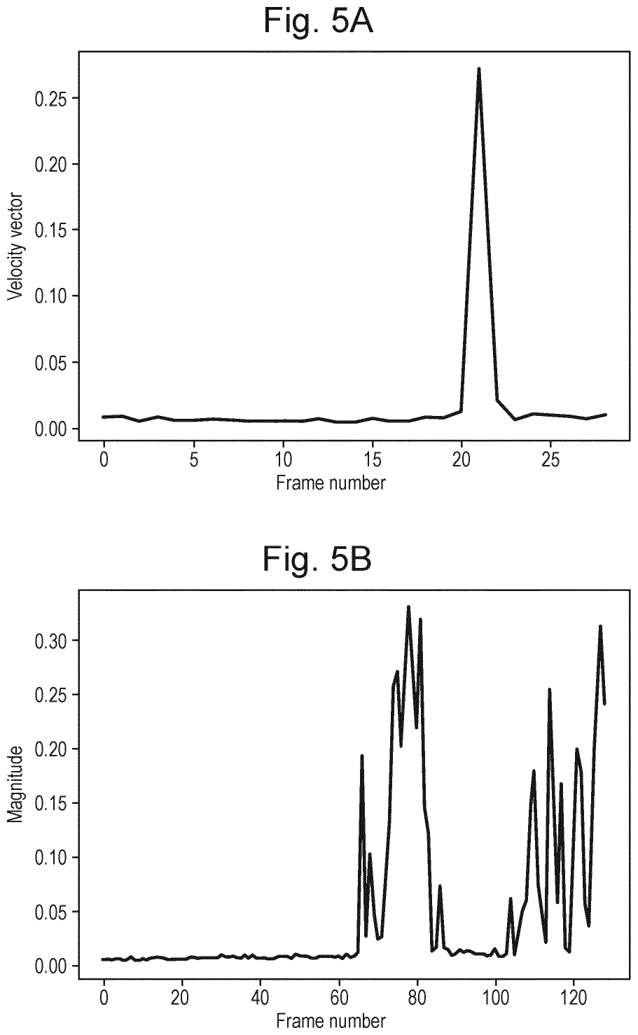

FIGS. 5A and 5B are graphs showing the intra-capillary flow of two different capillaries.

In Table 3 we show how CapillaryNet can calculate and derive the microvascular parameters suggested by Hilty [23] and Ince [24]. In addition, we introduce two new parameters that have not been previously monitored in microvascular videos: capillary hematocrit and intra-capillary flow velocity heterogeneity. CapillaryNet is a unique architecture that combines deep neural networks with salient object detection and two-frame motion estimation techniques to detect capillaries and classify the velocity of red blood cells. Our architecture paves the way to a unified method for near real-time bedside analysis of the microcirculation.

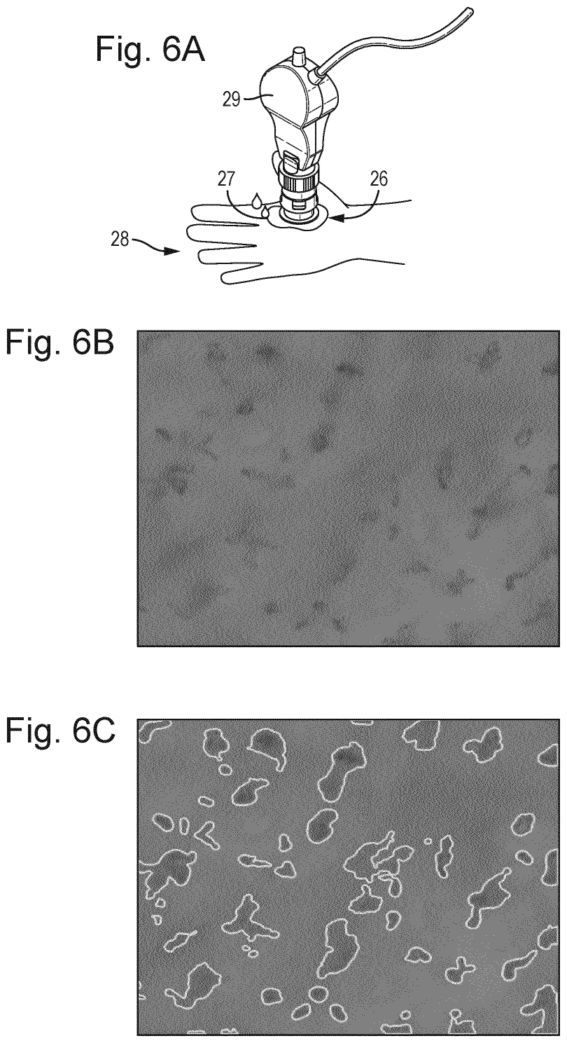

Videos were acquired on human subjects by a hand-held digital microscope (Digital Capillaroscope, Inspectis, Sweden) in the form of videos with a resolution of 1920×1080 at 30 fps for 20 seconds. The videos visualized the nutritive capillaries in the skin papillae in the dorsum region 26 of the hand 28, as shown in FIG. 6A. The dorsum region 26 was coated with a layer of transparent oil 27 before applying the microscope probe 29 to the skin. It will of course be appreciated that the images could be taken from elsewhere on the hand or on another part of the body (such as the eye, tongue, nails, etc.), however in this particular example a hand is used.

For each subject, a total of four to six videos were collected from neighbouring areas within the region of interest Data was obtained from 25 volunteers. The average age of the subjects was 30 years with a standard deviation of 5 years. A signed consent was obtained from all participants. The study was approved by the Regional Committees for medical and health research ethics of Norway.

FIG. 6B shows an image captured from the microvascular video taken from the hand 28. FIG. 6C shows the same image, with the borders of detected capillaries outlined.

To calculate the accuracy of the algorithm for capillary detection, a trained researcher analysed the obtained microvascular videos using in-house software for manual marking of capillaries with rectangular bounding boxes. Capillaries visible in different frames of each video were marked. The labelled bounding boxes were then compared with the algorithm output using the mean average precision (mAP) and Intersection over Union (IoU). The algorithm was trained by extracting the capillaries within the bounding boxes which were labelled by the independent researcher (˜2400 images of nutritive capillaries, ˜2600 images of skin with no capillaries, hair, stains and other artefacts).

The algorithm was trained and validated on ˜70% of the labelled data and then tested on the ˜30% of the labelled data. To calculate the accuracy of the algorithm for velocity detection, we correlated the output of the algorithm with the labelled values of the trained researcher on a scale from 1 to 3 (No or Slow Movement, Intermittent Flow, Constant Flow). The velocity detection deep neural network was trained on 500 videos each with a 30 fps frame rate and validated on 50 videos.

As outlined above, one of the outputs of CapillaryNet—the detected capillaries—is shown in FIG. 6C. The first part of our architecture detects the number of capillaries and calculates the density within a given area. This part consists of 2 stages, as outlined below.

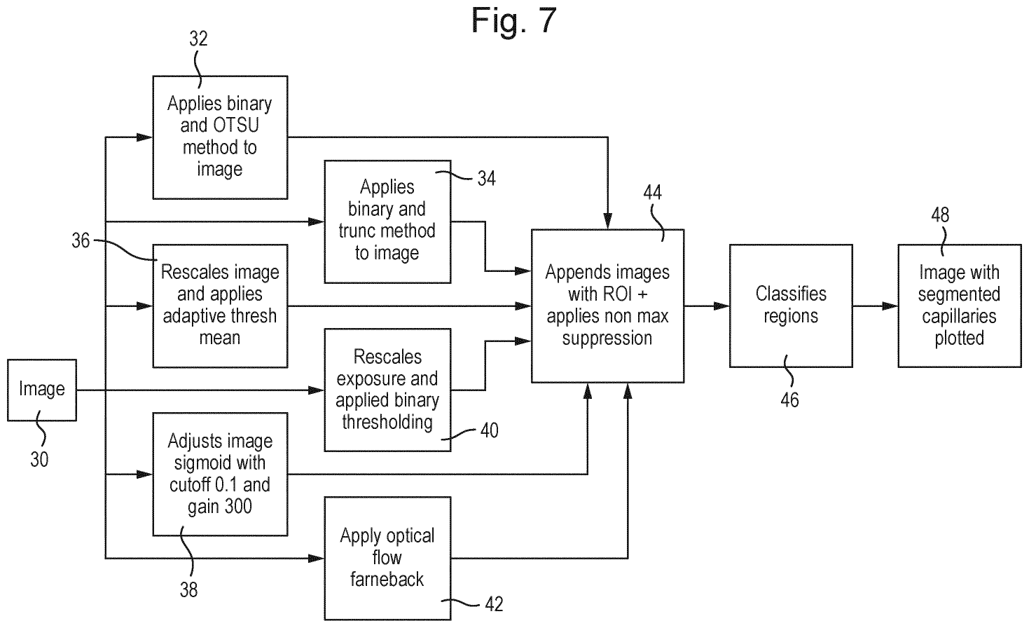

The first stage, as shown in FIG. 7, generates the proposed regions of interest (RoI), i.e. the candidate capillaries. RoIs are detected by passing the image 30 into six different pipelines and combining the output of those pipelines into one image with a bounding box around the RoIs. The goal of these pipelines is to detect as many RoIs as possible where capillaries might be located.

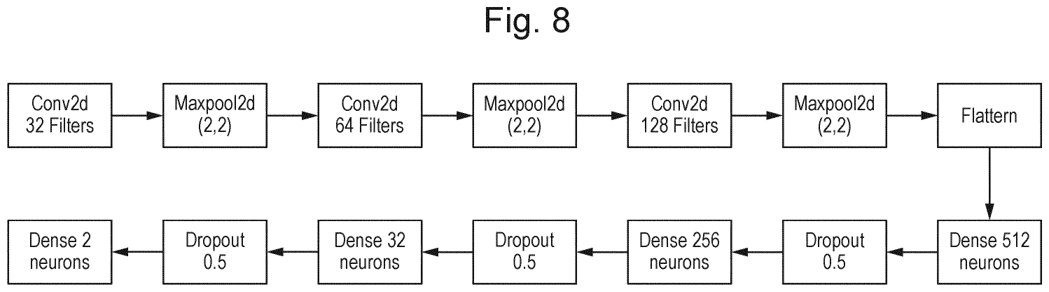

The second stage is passing these RoIs to a convolutional neural network part of the CapillaryNet, as shown in the block diagram of FIG. 8 and described in further detail below.

The model architecture consists of three convolutional neural networks separated with a max pooling layer. The output of those neurons is then passed to four neural networks with a dropout rate of 50% to reduce data overfitting. The CNN was optimized using Adam [47] and was trained on ˜50 epochs.

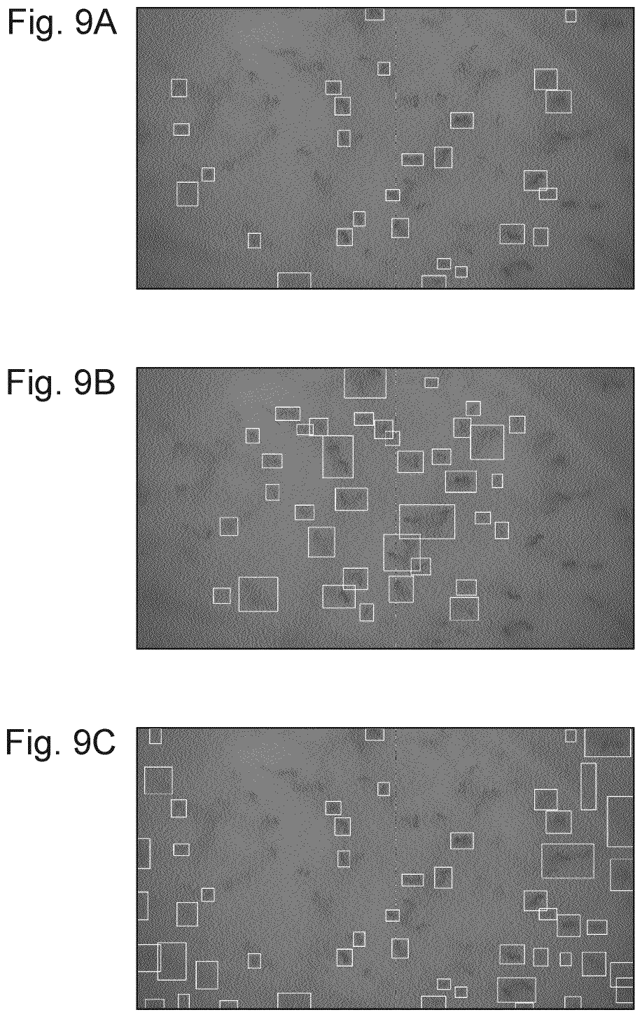

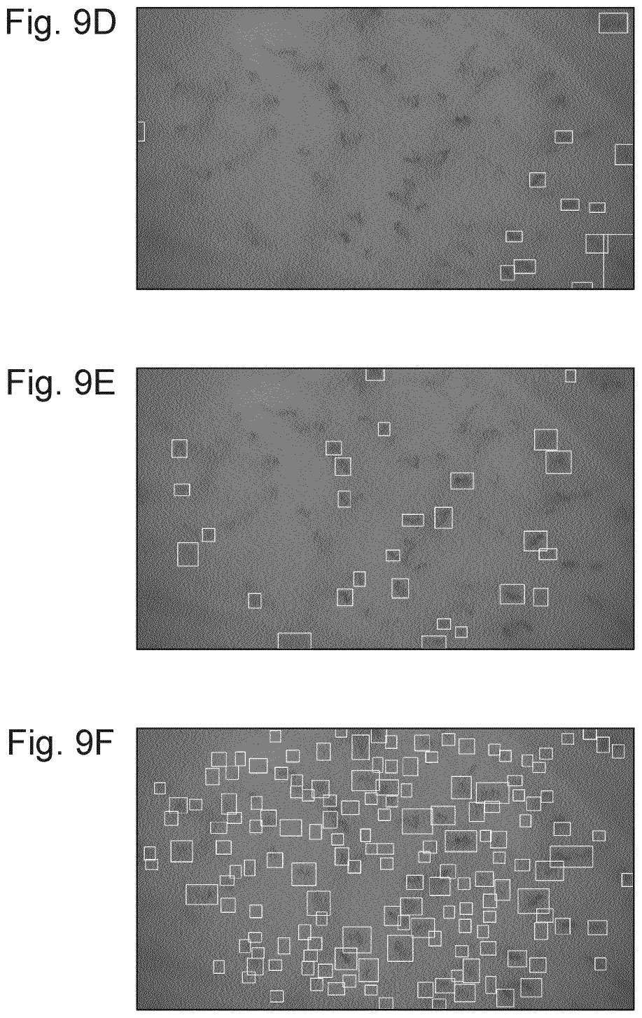

The first pipeline 32 applies an OTSU threshold. The OTSU threshold determines an optimal threshold value from the image histogram. The binary threshold then checks if the value of the pixels in the image are less than the derived number and sets it to zero; otherwise, it sets it to 255. An output image typical of this first pipeline 32 can be seen in FIG. 9A.

The second pipeline 34 applies a truncated threshold, where if the maximum threshold is higher than the value, then it is truncated with the threshold value. An output image typical of this second pipeline 34 can be seen in FIG. 9B.

The third pipeline 36 rescales the intensity of the image before and then applies a threshold value according to an adaptive mean. An output image typical of this third pipeline 36 can be seen in FIG. 9C.

The fourth pipeline 38 adjusts the image sigmoid with a specific cut-off and gain and then applies binary thresholding. An output image typical of this fourth pipeline 38 can be seen in FIG. 9D.

The fifth pipeline 40 rescales the intensity of the image and then applies a binary threshold like the first pipeline. The binary threshold simply checks if the value of the pixel is less than a certain number and sets it to zero; otherwise, it sets it to 255. An output image typical of this fifth pipeline 40 can be seen in FIG. 9E.

The sixth pipeline 42 detects movement between adjacent frames and highlights them as RoI. An output image typical of this sixth pipeline 42 can be seen in FIG. 9F.

Each of these outputs from the pipelines 32, 34, 36, 38, 40, 42 provides a respective capillary candidate map, i.e. it provides a respective image containing RoIs that particular pipeline has indicated may contain a capillary.

The values of all these pipelines have been adjusted and calculated in a trial-and-error manner.

In general, and as outlined above, each of these pipelines 32, 34, 36, 38, 40, 42 will generate a different set of RoIs, which are then projected back onto the original image. These sets of ROIs (i.e. each of the capillary candidate maps) are then passed to a non-max suppression function 44 to replace overlapping RoIs. The overall method (i.e. the combination of these pipelines 32, 34, 36, 38, 40, 42 and the CNN) is illustrated in FIG. 7, and the capillary candidate map output of each pipeline is shown in FIGS. 9A-F as outlined above. In this exemplary video, the adaptive threshold output pipelines detect more RoI than the sigmoid based adjustment detection, however it will be appreciated that with other videos (e.g. corresponding to other patients), different performance might be expected, for example due to the use of different illumination and different skins types.

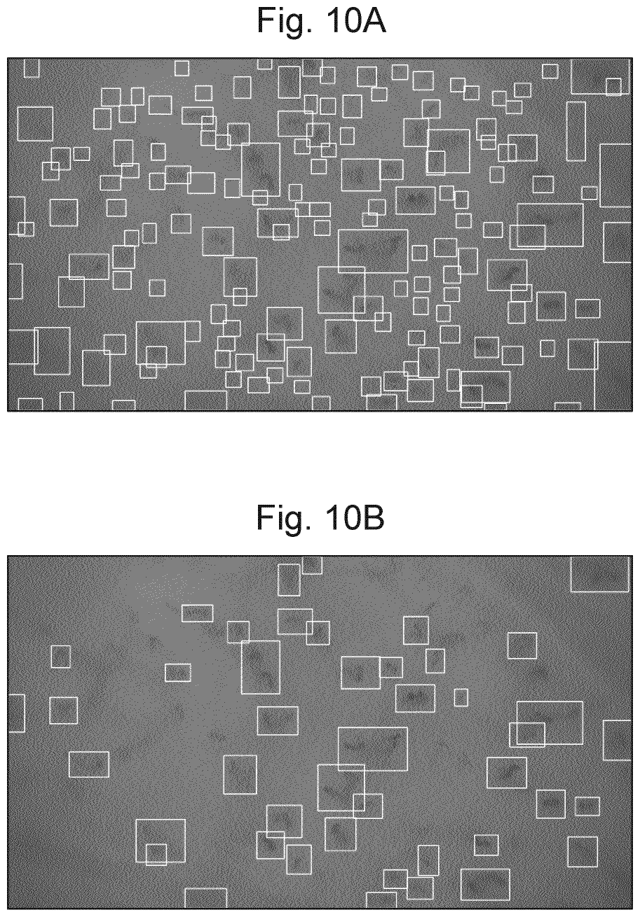

Therefore, the outputs of each of the pipelines 32, 34, 36, 38, 40, 42 are combined for each of the videos to maximize the probability of detecting all capillaries, thereby generating a combined capillary candidate map. FIG. 10A shows the combined output of all pipelines 32, 34, 36, 38, 40, 42. The pipelines 32, 34, 36, 38, 40, 42 may, in general, create many false positive RoIs. Therefore, we pass the combined capillary map (and thus the RoIs of that map) to a CNN 46 (a ‘first neural network’) which acts to classify each RoI as either containing a capillary or not. The output of the CNN 46 is shown in FIG. 10B.

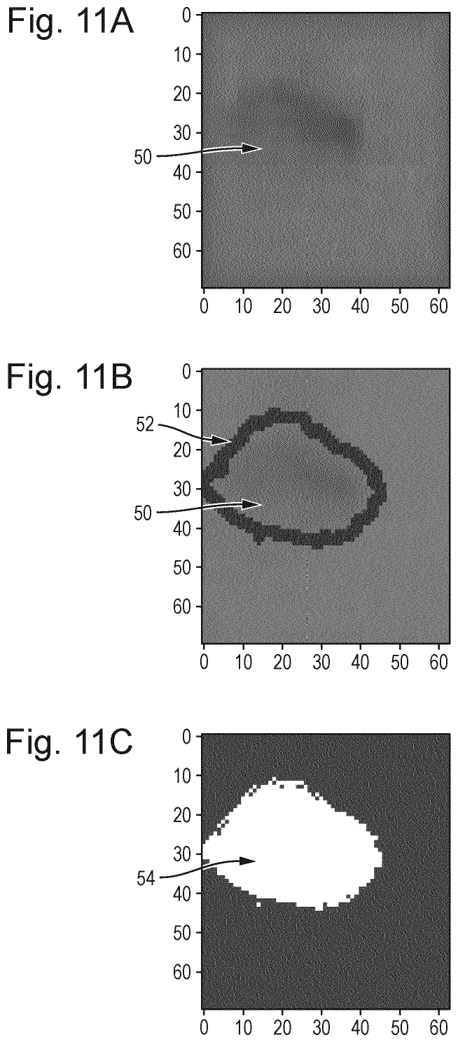

FIGS. 11A-C illustrate how the area of a capillary 50 may be determined. The area of the capillary 50 is then calculated based on the area occupied by the pixels associated with the capillary. As shown in FIG. 11B, the CapillaryNet system can detect the border 52 of the capillary 50 automatically. The pixels 54 within that boundary 52 (i.e. the white pixels 54 shown in FIG. 11C) constitute the area of that capillary 50. The heterogeneity of the perfusion of the capillary 50 can then be calculated to monitor how much red blood cell flows through the capillary 50.

FIG. 3A shows the capillary filled with red blood cells, while FIG. 3B shows the same capillary a couple of seconds later with white blood cells and plasma gaps. FIG. 3C shows the red blood cell distribution across time of the capillary derived using CapillaryNet. In this way, CapillaryNet is not only able to detect the capillary and its area, but also proceed to detect how much blood flows through it across time. This can provide the clinician with information of the average capillary hematocrit and its variation over time.

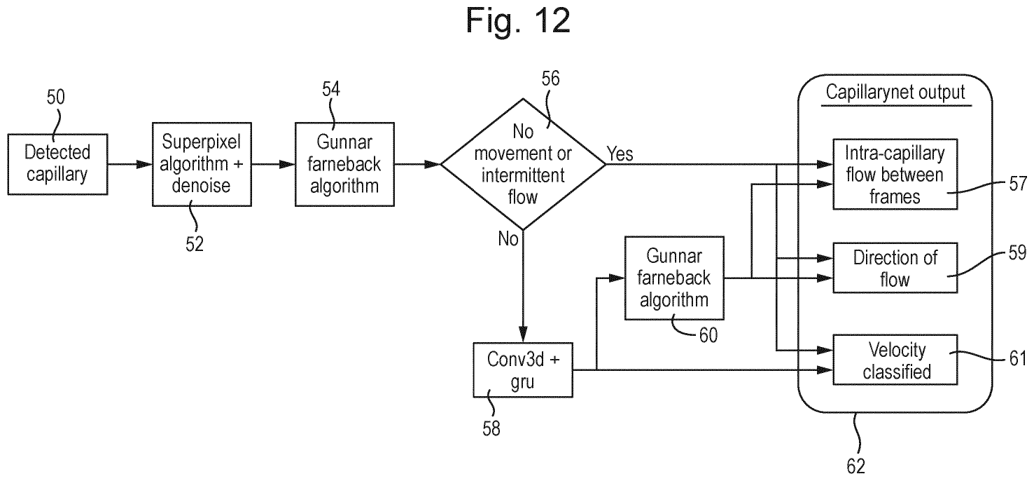

The capillary detected 50 is passed to the velocity detection stage of CapillaryNet, where the velocity detection method is illustrated in FIG. 12. It consists of two main parts, the Gunnar Farneback algorithm (GFA) [46] and a deep neural network part (a ‘second neural network’). GFA is a two-frame motion estimation algorithm where the approximation is done by calculating the quadratic polynomials and polynomial expansion transform between each frame. This polynomial expansion coefficient is used to derive the displacement fields of the pixel assuming the pixel intensities are constant between the two frames. By applying a stabilizing algorithm 52 to the frames and passing it to GFA 54, we obtain the difference in the location of the pixels which becomes the velocity vector.

A check 56 is made as to whether there is no movement or intermittent flow. If the velocity vector value is under 1.2, the capillary is classified as having no movement, and the direction of flow and the intra-capillary flow between frames is shown 57. If the velocity vector is larger than 1.2, it is passed to a deep learning algorithm 58 to classify its velocity as having a constant flow of intermittent flow. Then the direction of flow and intra-capillary flow between frames is determined using the GFA 60.

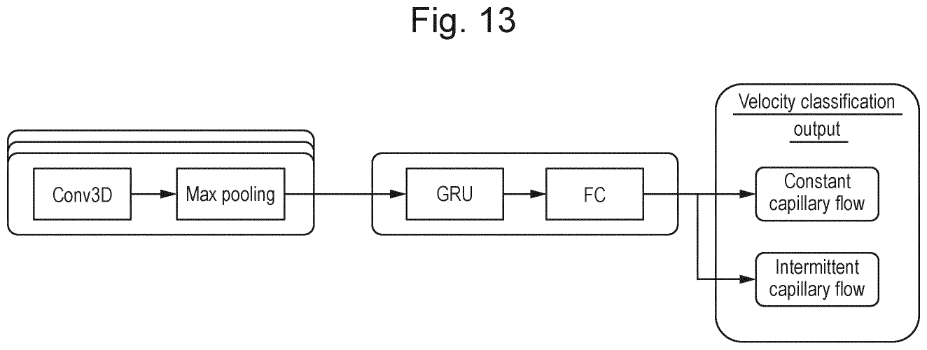

Thus the deep neural network 58 is not used to classify no-movement capillaries since doing so may be superfluous, adding time and computational resource overheads. The GFA 54 acts as a pre-filter to the deep neural network 58 and can determine if a capillary is worth passing to the deep neural network 58 in near real-time. The deep neural network where the data was trained on is shown in FIG. 13. In this particular example, the deep neural network for velocity detection includes a convolutional 3d (Conv3D) network paired with a gate recurrent unit (GRU), however it could alternatively be paired with a long short term memory (LSTM) network.

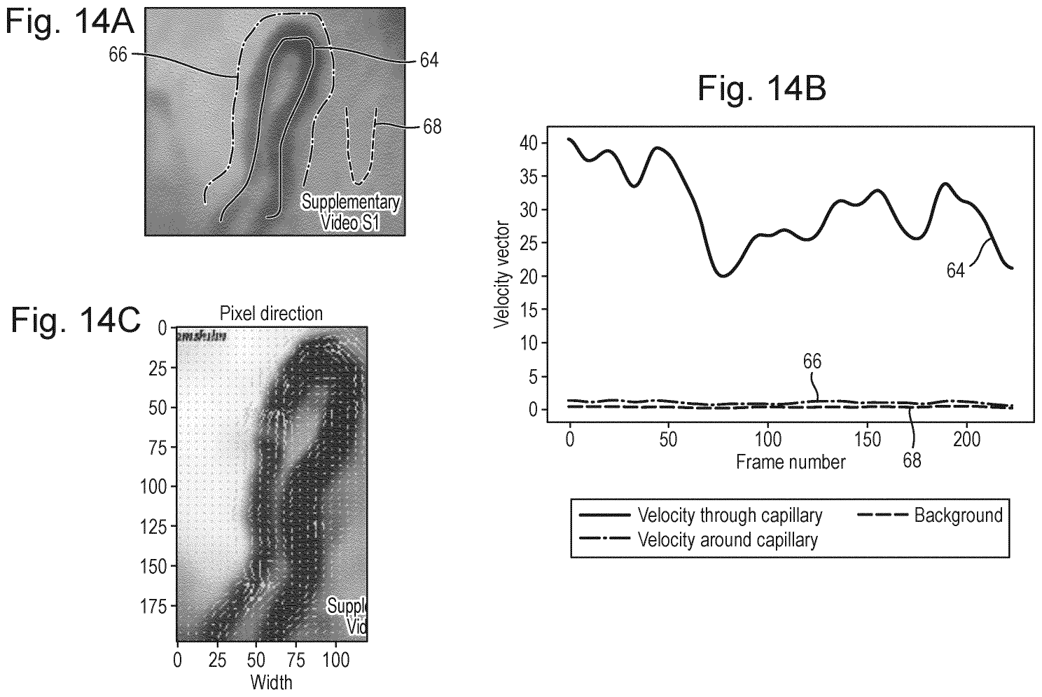

The velocity detection algorithm is demonstrated using a publicly available capillary video [49] in FIG. 14A. Measurements are taken from three different regions of the video to show the different values obtained from different parts of the same video, where the results are shown in the graph of FIG. 14B. The highest velocity vector values were found at the centre of the capillary, which is highlighted with a first line 64, having an average velocity vector value of 34.9. The lowest velocity vector was found on the side of the capillary and is highlighted with a further line 66, having an average velocity vector value of 0.7. The third line 68 corresponds to the background, having been randomly placed next to the capillary, and has an average velocity vector value of 0.1. The flow direction (i.e. vector) automatically derived by the CapillaryNet architecture can be seen in FIG. 14C.

Thus it will be appreciated that embodiments of the present invention provide a fully automated system that can detect capillaries in microvascular videos and classify the velocity of red blood cells by combining deep learning methods with rule-based algorithms and two-frame motion estimation techniques. Thereinafter, the system can quantify the area occupied by a capillary, calculate capillary density, and derive the intra-capillary heterogeneity of flow velocity and quantify capillary hematocrit.

By comparing the training time, detection time and accuracy of the disclosed method against prior art object detection algorithms Mask R-CNN, it can be seen that the method disclosed herein may provide an increase of +25% in accuracy, in half of the detection time.

Furthermore, by comparing the output of embodiments of the present invention to the results of manual capillary detection and velocity quantification performed by trained researchers, it can be seen that CapillaryNet takes 0.2 seconds to detect capillaries in a video whilst it can take up to 2 minutes for a trained researcher to take the capillaries in the video. With an algorithm that can detect capillaries at 4 fps with 92% accuracy, a significant advancement toward real-time capillary detection and area quantification is provided by the approach described herein.

To detect capillaries, CapillaryNet passes the video into a 2-stage process. The first stage aims to detect the regions of interest (RoI) and the second stage passes these RoI into a convolutional neural network to classify if it contains a capillary. If a capillary is detected, the area the capillary occupies is derived by applying a rule-based algorithm. The capillary density is calculated by replicating this step across the whole image. To calculate the content of red blood cells (capillary hematocrit) across time, the area occupied by the capillary in the RoI is calculated across the video. To classify the velocity, we pass the capillary detected to a deep neural network that was trained on researcher classification. Furthermore, we use Farneback algorithm to calculate the intra-capillary heterogeneity across consecutive frames on the video and determine the direction of flow.

Furthermore, the present invention may increase the number of microvascular parameters that can be monitored beyond what is currently possible today with prior art approaches, known in the art per se. Firstly, velocity classification is standardised by using a trained algorithm to detect it. Secondly, the heterogeneity of the flow velocity can be calculated for in a single capillary. Thirdly, the hematocrit of each capillary can be estimated, providing novel information on the potential of each capillary to deliver oxygen to the surrounding tissue.

Thus deep learning techniques are combined with salient object detection and two-frame motion estimation techniques to present a novel method that may automatically:
1) Detect capillaries using deep learning techniques;
2) Quantify the area occupied by a capillary and calculate capillary density using salient object detection techniques;
3) Quantify capillary hematocrit using salient object detection techniques;
4) Track the intra-capillary flow heterogeneity and direction using two-frame motion estimation techniques; and
5) Classify velocity using deep learning techniques.

Those skilled in the art will appreciate that the specific embodiments described herein are merely exemplary and that many variants within the scope of the invention are envisaged.

### Annex: Tables

TABLE 1

| | | | | | Test Data |
|---|---|---|---|---|---|
| Name | Training Time | | Detection Time | | Accuracy |
| Trained | ~40 | hours | ~120 | seconds | ~100% |
| Researcher | | | | | |
| Mask R-CNN | ~120 | hours | ~0.4 | seconds | ~67.5% |
| CapillaryNet: | ~1 | hour | ~0.2 | seconds | ~92.5% |
| Capillary Detection | | | | | |

Table 1. Benchmark of CapillayNet capillar detection against Mask R-CNN and manual analysis performed by a trained researcher. It is estimated that on average it takes 5 working days for a researcher to be trained in capillar detection.

TABLE 2

| | | Intermittent | Constant | |
|---|---|---|---|---|
| | No Flow | Flow | Flow | Average |
| Name | Accuracy | F1 Score | F1 Score | Accuracy |
| CapillaryNet: | ~80.0% | ~94.5% | ~91.8% | ~88.8% |
| Velocity | | | | |
| Detection | | | | |

Table 2. We show the accuracy of CapillaryNet in classifying the velocities into 3 categories, with the highest accuracy achieved in Intermittent flow detection.

TABLE 3

| | |
|---|---|
| Parameter | CapillaryNet Detection Description |

Per image or video

| | |
|---|---|
| Total vessel density | Sum of area occupied by capillaries which is |
| for capillaries | derived by the total number of pixels occupied |
| | by the detected capillary divided by the |
| | dimension of the image |
| Functional capillary | Sum of area occupied by capillaries that |
| density | contain moving red blood cells which is |
| | derived by the total number of pixels occupied |
| | by the detected capillary divided by the |
| | dimension of the image |
| Mean capillary velocity | Mean value of the red blood cell velocity in |
| | the capillaries detected in the video |

Per vessel

| | |
|---|---|
| Length | Vessel length detected by CapillaryNet |
| | medial axis skeletonization |
| Mean capillary velocity | Mean red blood flow is derived from |
| | Farneback algorithm. The mean is taken by |
| | averaging the velocity flow across all frames |
| Intra- and inter-capillary | Derived from Gunnar Farneback algorithm |
| heterogeneity of flow | where we plot the pixel velocity vector across |
| velocity | all frames |
| Capillary hematocrit | Derived from rule-based algorithm, where we |
| | plot the amount of red blood cells across the |
| | frames |

Table 3. We describe how CapillaryNet can calculate and derive the applicable parameters suggested for microcirculation analysis by Hilty et al [23] and Ince et al [24]. In addition, we introduce two new parameters that can uniquely identified and calculated by CapillaryNet: Intra-capillary heterogeneity of flow velocity and capillar hematocrit.

### REFERENCES

[1] D. De Backer et al., “How to evaluate the microcirculation: report of a round table conference,” Crit. Care, vol. 11, no. 5, p. R101, 2007, doi: 10.1186/cc6118.
[2] “What is the definition of capillaries?” https://www.webmd.com/heart-disease/heart-failure/qa/what-is-the-definition-of-capillaries (accessed Aug. 11, 2020).
[3] Libretexts, “18.2F: Capillaries,” Jul. 21, 2018. https://med.libretexts.org/Bookshelves/Anatomy_and_Physiology/Book%3A_Anatomy_and_Physiology_(Boundless)/18%3A_Cardiovascular_System%3A_Blood_Vessels/18.2%3A_Arteries/18.2F%3A_Capillaries (accessed Aug. 11, 2020).
[4] G. Guven, M. P. Hilty, and C. Ince, “Microcirculation: Physiology, Pathophysiology, and Clinical Application,” Blood Purif., vol. 49, no. 1-2, pp. 143-150, 2020, doi: 10.1159/000503775.
[5] M. J. S. Parker and N. W. McGill, “The Established and Evolving Role of Nailfold Capillaroscopy in Connective-Tissue Disease,” in Connective Tissue Disease—Current State of the Art [Working Title], IntechOpen, 2019.
[6] V. Nama, J. Onwude, I. T. Manyonda, and T. F. Antonios, “Is capillary rarefaction an independent risk marker for cardiovascular disease in South Asians?,” J. Hum. Hypertens., vol. 25, no. 7, pp. 465-466, July 2011, doi: 10.1038/jhh.2011.1.
[7] A. J. H. M. Houben, R. J. H. Martens, and C. D. A. Stehouwer, “Assessing Microvascular Function in Humans from a Chronic Disease Perspective,” J. Am. Soc. Nephrol., vol. 28, no. 12, pp. 3461-3472, December 2017, doi: 10.1681/ASN.2017020157.
[8] J. C. de Graaff, D. T. Ubbink, J. A. van der Spruit, S. M. Lagarde, and M. J. H. M. Jacobs, “Influence of peripheral arterial disease on capillary pressure in the foot,” J. Vasc. Surg., vol. 38, no. 5, pp. 1067-1074, November 2003, doi: 10.1016/s0741-5214(03)00603-7.
[9] B. Fagrell and M. Intaglietta, “Microcirculation: its significance in clinical and molecular medicine,” J. Intern. Med., vol. 241, no. 5, pp. 349-62, May 1997, doi: 10.1046/j.1365-2796.1997.125148000.x.
[10] P. M. Houtman, C. G. Kallenberg, A. A. Wouda, and T. H. The, “Decreased nailfold capillary density in Raynaud's phenomenon: a reflection of immunologically mediated local and systemic vascular disease?,” Ann. Rheum. Dis., vol. 44, no. 9, pp. 603-609, September 1985, doi: 10.1136/ard.44.9.603.
[11] H. Schmeling et al., “Nailfold capillary density is importantly associated over time with muscle and skin disease activity in juvenile dermatomyositis,” Rheumatology, vol. 50, no. 5, pp. 885-893, May 2011, doi: 10.1093/rheumatology/keq407.
[12] B. D. Duscha et al., “Capillary density of skeletal muscle: a contributing mechanism for exercise intolerance in class II-III chronic heart failure independent of other peripheral alterations,” J. Am. Coll. Cardiol., vol. 33, no. 7, pp. 1956-1963, June 1999, doi: 10.1016/s0735-1097(99)00101-1.
[13] J. L. Robbins et al., “Relationship between leg muscle capillary density and peak hyperemic blood flow with endurance capacity in peripheral artery disease,” J. Appl. Physiol., vol. 111, no. 1, pp. 81-86, July 2011, doi: 10.1152/japplphysiol.00141.2011.
[14] M. Moeini et al., “Compromised microvascular oxygen delivery increases brain tissue vulnerability with age,” Sci. Rep., vol. 8, no. 1, p. 8219, May 2018, doi: 10.1038/s41598-018-26543-w.
[15] A. López et al., “Effects of early hemodynamic resuscitation on left ventricular performance and microcirculatory function during endotoxic shock,” Intensive Care Med Exp, vol. 3, no. 1, p. 49, December 2015, doi: 10.1186/s40635-015-0049-y.
[16] D. De Backer, J. Creteur, J.-C. Preiser, M.-J. Dubois, and J.-L. Vincent, “Microvascular blood flow is altered in patients with sepsis,” Am. J. Respir. Crit. Care Med., vol. 166, no. 1, pp. 98-104, July 2002, doi: 10.1164/rccm.200109-016oc.
[17] T. Wester, Z. A. Awan, T. S. Kvernebo, G. Salerud, and K. Kvernebo, “Skin microvascular morphology and hemodynamics during treatment with veno-arterial extra-corporeal membrane oxygenation,” Clin. Hemorheol. Microcirc., vol. 56, no. 2, pp. 119-131, 2014, doi: 10.3233/CH-131670.
[18] A. C. Shore, “Capillaroscopy and the measurement of capillary pressure,” Br. J. Clin. Pharmacol., vol. 50, no. 6, pp. 501-513, December 2000, doi: 10.1046/j.1365-2125.2000.00278.x.
[19] M. S. Goligorsky, “Microvascular rarefaction: the decline and fall of blood vessels,” Organogenesis, vol. 6, no. 1, pp. 1-10, January 2010, doi: 10.4161/org.6.1.10427.
[20] A. Edwards-Richards et al., “Capillary rarefaction: an early marker of microvascular disease in young hemodialysis patients,” Clin. Kidney J., vol. 7, no. 6, pp. 569-574, December 2014, doi: 10.1093/ckj/sfu106.
[21] C. C. Michel, “Starling: the formulation of his hypothesis of microvascular fluid exchange and its significance after 100 years,” Exp. Physiol., vol. 82, no. 1, pp. 1-30, January 1997, doi: 10.1113/expphysiol.1997.sp004000.
[22] H. S. Wei et al., “Erythrocytes Are Oxygen-Sensing Regulators of the Cerebral Microcirculation,” Neuron, vol. 91, no. 4, pp. 851-862, August 2016, doi: 10.1016/j.neuron.2016.07.016.
[23] M. P. Hilty, P. Guerci, Y. Ince, F. Toraman, and C. Ince, “MicroTools enables automated quantification of capillary density and red blood cell velocity in handheld vital microscopy,” Commun Biol, vol. 2, p. 217, June 2019, doi: 10.1038/s42003-019-0473-8.
[24] C. Ince et al., “Second consensus on the assessment of sublingual microcirculation in critically ill patients: results from a task force of the European Society of Intensive Care Medicine,” Intensive Care Med., vol. 44, no. 3, pp. 281-299, March 2018, doi: 10.1007/s00134-018-5070-7.
[25] Z.-Q. Zhao, P. Zheng, S.-T. Xu, and X. Wu, “Object Detection With Deep Learning: A Review,” IEEE Trans Neural Netw Learn Syst, vol. 30, no. 11, pp. 3212-3232, November 2019, doi: 10.1109/TNNLS.2018.2876865.
[26] A. Krizhevsky, I. Sutskever, and G. E. Hinton, “ImageNet Classification with Deep Convolutional Neural Networks,” in Advances in Neural Information Processing Systems 25, F. Pereira, C. J. C. Burges, L. Bottou, and K. Q. Weinberger, Eds. Curran Associates, Inc., 2012, pp. 1097-1105.
[27] O. Russakovsky et al., “ImageNet Large Scale Visual Recognition Challenge,” Int. J. Comput. Vis., vol. 115, no. 3, pp. 211-252, December 2015, doi: 10.1007/s11263-015-0816-y.
[28] W. Wang, Q. Lai, H. Fu, J. Shen, H. Ling, and R. Yang, “Salient Object Detection in the Deep Learning Era: An In-Depth Survey,” arXiv [cs.CV], Apr. 19, 2019.
[29] A. Borji, M.-M Cheng, H. Jiang, and J. Li, “Salient Object Detection: A Benchmark,” IEEE Trans. Image Process., vol. 24, no. 12, pp. 5706-5722, December 2015, doi: 10.1109/TIP.2015.2487833.
[30] A. Borji, M.-M Cheng, Q. Hou, H. Jiang, and J. Li, “Salient Object Detection: A Survey,” arXiv [cs.CV], Nov. 18, 2014.
[31] K. He, G. Gkioxari, P. Dollár, and R. Girshick, “Mask r-cnn,” in Proceedings of the IEEE international conference on computer vision, 2017, pp. 2961-2969, [Online]. Available: http://openaccess.thecvf.com/content_iccv_2017/html/He_Mask_R-CNN_ICCV_2017_paper.html.
[32] T.-Y. Lin et al., “Microsoft COCO: Common Objects in Context,” in Computer Vision—ECCV 2014, 2014, pp. 740-755, doi: 10.1007/978-3-319-10602-1_48.
[33] S. Ren, K. He, R. Girshick, and J. Sun, “Faster R-CNN: Towards Real-Time Object Detection with Region Proposal Networks,” in Advances in Neural Information Processing Systems 28, C. Cortes, N. D. Lawrence, D. D. Lee, M. Sugiyama, and R. Garnett, Eds. Curran Associates, Inc., 2015, pp. 91-99.
[34] J. G. G. Dobbe, G. J. Streekstra, B. Atasever, R. van Zijderveld, and C. Ince, “Measurement of functional microcirculatory geometry and velocity distributions using automated image analysis,” Med. Biol. Eng. Comput., vol. 46, no. 7, pp. 659-670, July 2008, doi: 10.1007/s11517-008-0349-4.
[35] H. Deng, W. Zhang, E. Mortensen, T. Dietterich, and L. Shapiro, “Principal Curvature-Based Region Detector for Object Recognition,” in 2007 IEEE Conference on Computer Vision and Pattern Recognition, June 2007, pp. 1-8, doi: 10.1109/CVPR.2007.382972.
[36] J. Tam, J. A. Martin, and A. Roorda, “Noninvasive visualization and analysis of parafoveal capillaries in humans,” Invest. Ophthalmol. Vis. Sci., vol. 51, no. 3, pp. 1691-1698, March 2010, doi: 10.1167/iovs.09-4483.
[37] L. S. Geyman et al., “Peripapillary perfused capillary density in primary open-angle glaucoma across disease stage: an optical coherence tomography angiography study,” Br. J. Ophthalmol., vol. 101, no. 9, pp. 1261-1268, September 2017, doi: 10.1136/bjophthalmol-2016-309642.
[38] R. Bezemer et al., “Rapid automatic assessment of microvascular density in sidestream dark field images,” Med. Biol. Eng. Comput., vol. 49, no. 11, pp. 1269-1278, November 2011, doi: 10.1007/s11517-011-0824-1.
[39] S. U. Demir, R. Hakimzadeh, R. H. Hargraves, K. R. Ward, E. V. Myer, and K. Najarian, “An automated method for analysis of microcirculation videos for accurate assessment of tissue perfusion,” BMC Med. Imaging, vol. 12, p. 37, December 2012, doi: 10.1186/1471-2342-12-37.
[40] E. C. Boerma, K. R. Mathura, P. H. J. van der Voort, P. E. Spronk, and C. Ince, “Quantifying bedside-derived imaging of microcirculatory abnormalities in septic patients: a prospective validation study,” Crit. Care, vol. 9, no. 6, pp. R601-6, September 2005, doi: 10.1186/cc3809.
[41] R. C. Arnold et al., “Point-of-care assessment of microvascular blood flow in critically ill patients,” Intensive Care Med., vol. 35, no. 10, pp. 1761-1766, October 2009, doi: 10.1007/s00134-009-1517-1.
[42] V. S. K. Edul, C. Enrico, B. Laviolle, A. R. Vazquez, C. Ince, and A. Dubin, “Quantitative assessment of the microcirculation in healthy volunteers and in patients with septic shock,” Crit. Care Med., vol. 40, no. 5, pp. 1443-1448, May 2012, doi: 10.1097/CCM.0b013e31823dae59.
[43] A. Dubin et al., “Increasing arterial blood pressure with norepinephrine does not improve microcirculatory blood flow: a prospective study,” Crit. Care, vol. 13, no. 3, p. R92, June 2009, doi: 10.1186/cc7922.
[44] S. Fredly, D. Fugelseth, C. S. Nygaard, E. G. Salerud, T. Stiris, and K. Kvernebo, “Noninvasive assessments of oxygen delivery from the microcirculation to skin in hypothermia-treated asphyxiated newborn infants,” Pediatr. Res., vol. 79, no. 6, pp. 902-906, June 2016, doi: 10.1038/pr.2016.16.
[45] M. P. Hilty et al., “Assessment of endothelial cell function and physiological microcirculatory reserve by video microscopy using a topical acetylcholine and nitroglycerin challenge,” Intensive Care Medicine Experimental, vol. 5, no. 1, p. 26, May 2017, doi: 10.1186/s40635-017-0139-0.
[46] G. Famebäck, “Two-Frame Motion Estimation Based on Polynomial Expansion,” in Image Analysis, 2003, pp. 363-370, doi: 10.1007/3-540-45103-X_50.
[47] D. P. Kingma and J. Ba, “Adam: A Method for Stochastic Optimization,” arXiv [cs.LG], Dec. 22, 2014.
[48] F. Pedregosa et al., “Scikit-learn: Machine Learning in Python,” J. Mach. Learn. Res., vol. 12, no. 85, pp. 2825-2830, 2011, Accessed: Sep. 21, 2020. [Online]. Available: https://www.jmlr.org/papers/v12/pedregosa11a.html.
[49] M. V. Volkov et al., “Video capillaroscopy clarifies mechanism of the photoplethysmographic waveform appearance,” Sci. Rep., vol. 7, no. 1, p. 13298, October 2017, doi: 10.1038/s41598-017-13552-4.

1. An automated method for analysing capillaries in a plurality of images acquired from a subject, the method comprising the following steps:
a) acquiring the plurality of images;
b) generating a plurality of capillary candidate maps for each of said images, each capillary candidate map comprising one or more regions of interest for each of said images, wherein for each image, each of the respective capillary candidate maps is generated by comparing said image to a different criterion;
c) combining said capillary candidate maps to generate a combined capillary candidate map;
d) using a first neural network to determine a respective location of one or more detected capillaries in said combined capillary candidate map;
e) using a second neural network to determine an optical flow of said detected capillaries; and
f) extracting one or more capillary parameters using said detected capillaries and/or said determined flow.

2. (canceled)

3. The method as claimed in claim 1, wherein the plurality of images form a video.

4. The method as claimed in claim 1, wherein the plurality of images comprise microscopy images and wherein the step of acquiring the images comprises using a microscope probe to generate said images.

5. (canceled)

6. The method as claimed in claim 1, further comprising carrying out one or more of:
a) modifying a colour balance of one or more of said images;
b) modifying a white balance of one or more of said images;
c) modifying a light level of one or more of said images;
d) modifying a gamma level of one or more of said images;
e) modifying a red-green-blue (RGB) curve of one or more of said images;
f) applying a sharpening filter to one or more of said images; and/or
g) applying a noise reduction process to one or more of said images.

7. The method as claimed in claim 1, further comprising carrying out a motion compensation process.

8. The method as claimed in claim 1, wherein the step of generating the plurality of capillary candidate maps comprises inputting each image to a plurality of pipelines; and wherein a first pipeline is arranged to generate a first capillary candidate map, said first pipeline being arranged to generate an image histogram from each image and determines an optimal pixel value threshold, said first pipeline being further arranged to classify each pixel in said image with a first label if a value of said pixel is less than the determined optimal pixel value threshold, and with a second label if the value of said pixel is equal to or greater than the determined optimal pixel value threshold.

9. (canceled)

10. The method as claimed in claim 8, wherein a second pipeline is arranged to generate a second capillary candidate map, said second pipeline being arranged to compare a pixel value of each pixel in each image to a truncation threshold, said second pipeline being further arranged to set the value of each pixel having a pixel value greater than said truncation threshold to said truncation threshold.

11. The method as claimed in claim 8, wherein a third pipeline is arranged to generate a third capillary candidate map, said third pipeline being arranged to rescale an intensity of the image and to apply a threshold value to said rescaled image according to an adaptive mean.

12. The method as claimed in claim 8, wherein a fourth pipeline is arranged to generate a fourth capillary candidate map, said fourth pipeline being arranged to adjust an image sigmoid using a cut-off and gain and to apply a binary thresholding process.

13. The method as claimed in claim 8, wherein a fifth pipeline is arranged to generate a fifth capillary candidate map, said fifth pipeline being arranged to rescale the intensity of the image and to apply a binary threshold.

14. The method as claimed in claim 8, wherein a sixth pipeline is arranged to generate a sixth capillary candidate map, said sixth pipeline being arranged to detect a movement between subsequent images and to label a region of the image associated with said movement as a region of interest.

15. The method as claimed in claim 1, wherein the plurality of capillary candidate maps are processed using a non-max suppression process to replace overlapping regions of interest.

16. The method as claimed in claim 1, further comprising generating a validated training data set by manually labelling a plurality of capillaries in a plurality of images and supplying said validated training data set to the first neural network during a training phase.

17. The method as claimed in claim 1, wherein the first neural network comprises a convolutional neural network, and wherein the second neural network comprises a deep neural network.

18. The method as claimed in claim 1, wherein the step of determining the optical flow of the detected capillaries comprises applying a Gunnar Farneback algorithm to the detected capillaries prior to use of the second neural network.

19. The method as claimed in claim 1, wherein a respective velocity vector value for each detected capillary is compared to a velocity vector value threshold and wherein only capillaries having a velocity vector value above the velocity vector value threshold are passed to the second neural network.

20. (canceled)

21. (canceled)

22. The method as claimed in claim 1, further comprising performing quality analysis on one or more of the plurality of images to determine whether said images meet a quality threshold.

23. (canceled)

24. The method as claimed in claim 1, wherein the parameter comprises one or more of the group comprising:
a) functional capillary density (number of capillaries per square millimetre);
b) mean capillary distance—average distance of nearest-neighbour pairs of capillaries;
c) capillary flow velocity (CFV)—either quantified in an ordinal scale or by a velocity (e.g. millimetre per second);
d) the size of each capillary;
e) the colour density of each capillary, which is related to the level of oxygenation of the red blood cells; and/or
f) the blood area or blood volume—the area or estimated volume occupied by the capillaries in relation to the total area or volume.

25. A device arranged to carry out automated analysis of capillaries in a plurality of images acquired from a subject, the device comprising:
an image acquisition module arranged to acquire the plurality of images; and
a processing module arranged to:
generate a plurality of capillary candidate maps for each of said images, each capillary candidate map comprising one or more regions of interest for each of said images, wherein for each image, each of the respective capillary candidate maps is generated by the processing module by comparing said image to a different criterion;
combine said capillary candidate maps to generate a combined capillary candidate map;
use a first neural network to determine a respective location of one or more detected capillaries in said combined capillary candidate map;
use a second neural network to determine an optical flow of said detected capillaries; and
extract one or more capillary parameters using said detected capillaries and/or said determined flow.

26. (canceled)

27. A non-transitory computer-readable medium comprising instructions that, when executed by a processor, cause the processor to carry out the method of claim 1.

28-30. (canceled)
